(19) United States
(12) Patent Application Publication
(10) Pub. No.: US 2025/0239949 A1
(43) Pub. Date: Jul. 24, 2025

(54) Mobile Compressor Startup Drive

(71) Applicant: ARCTIC COMPRESSOR, LLC, Superior, WI (US)

(72) Inventors: Steven Potter, Superior, WI (US); Eric M. Nistler, Superior, WI (US); Stephen J Talaga, Superior, WI (US)

(21) Appl. No.: 18/415,852

(22) Filed: Jan. 18, 2024

(51) Int. Cl. H02P 1/16; F04D 25/06

(52) U.S. Cl. CPC H02P 1/16; F04D 25/06

(57) ABSTRACT

A mobile compressor startup drive comprising: a generator; an inverter; a charger; and a power bank. The generator may be rated to, at a minimum, supply a steady-state current required by a compressor. The power bank provides an additional current through the inverter to the compressor to meet an inrush current demand of the compressor during startup of the compressor. The charger may recharge the power bank.

### FIELD OF USE

The present disclosure relates, in general, to a mobile compressor drive. More specifically, the present disclosure relates to devices, systems, and methods of eliminating the need to use an oversized (at steady-state) electric generator to startup and power a compressor.

### BACKGROUND

Generally, electrically driven compressor motors require a large inrush of current that may be orders of magnitude greater than the steady-state power requirement of the motor. The available torque from the motor and total rotating mass determines the size and duration of the inrush current spike. This inrush current can peak exponentially over a motor's rated power. Typically, the inrush current only lasts a fraction of a second and significantly reduces as the compressor reaches its steady-state.

Typically, compressors are connected to a utility power grid capable of sourcing the inrush current needed when the compressor is started. When not connected to a utility power grid, starting a compressor from a generator may be very difficult or impossible. Using a generator or other power source that is unable to flexibly source the inrush current, a generator or other power source rated greater than the steady-state current requirements is needed. To meet the inrush current demands of a compressor's electric motor typically requires a generator or power source with a current capacity that is three to five times greater than what is needed when the compressor is in its steady-state current rating of a compressor's electric motor. Having to use a generator or other power source capable of handling the required current capacity results in higher costs to purchase, fuel, and operate the generator or other power source when that extra capability is only required for tiny fractions of its operational lifespan.

Some techniques may be used to limit how overrated the generator needs to be to handle the inrush current. First, modern generators often feature the ability to store small amounts of excess or surge energy in capacitor banks and/or possess the ability to dynamically control the generator's throttle position to compensate for inrush loads. Second, a variable frequency drive (VFD) can be added to the system. This allows the compressor speed to ramp up over a longer period of time, which reduces the peak load required. Another technique that can be used alone or in conjunction with a VFD is utilizing a soft starter that is capable of adding to the amount of surge current available. Using the above techniques can reduce the generator size, but it will still require the generator to be substantially overrated than what would be required under steady-state conditions.

Thus, what is needed is a power system that supplies the inrush current needed during start-up of a compressor, thereby only requiring a smaller sized generator to supply the steady state current.

### SUMMARY

To minimize the limitations in the prior art and to minimize other limitations that will become apparent upon reading and understanding the present specification, the present disclosure discloses new and useful devices, systems, and methods of reducing the size and/or rating of a generator that is being used to power a compressor or other similar type of motor, to match the power requirements that are necessary during steady-state use of the compressor, but that also handles the power surges need upon the startup of the compressor.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

Electrically driven compressors may demand inrush current to start up, which may be many magnitudes higher than the steady-state current requirement. When using a standalone power source, such as a generator, separate from a utility power grid, a much higher-rated generator is required to supply the start-up inrush current, even though the power or current required by the compressor when running at a steady-state is significantly lower. To solve this problem, the systems, devices, and methods of the present disclosure may incorporate a power bank, power bank charger, and/or inverter, which allows the system to use power stored in the power bank to handle the higher current requirements during the very brief start-up of the compressor.

One embodiment of the present disclosure may comprise a generator, a power bank, power bank charger, and inverter, which are operatively and electrically connected to each other and to a compressor that is powered by the generator. The power bank is charged by the generator through the power bank charger. The inverter converts the batteries direct current to alternating current, which then provides the alternating current to the compressor when the compressor is started up. The system may also include a variable frequency drive (VFD) that further reduces the start-up surge current requirement of the compressor. The power bank and/or the VFD allows a generator to be sized and rated for the power/current requirements of a compressor in steady-state.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of an electrically driven compressor.

FIG. 1A is an illustration of one embodiment of a compressor control unit.

FIG. 2 is an illustration of one embodiment of an inverter.

FIG. 3 is an illustration of one embodiment of a power bank charger.

FIG. 4 is an illustration of one embodiment of a power bank.

FIG. 5 is an illustration of one embodiment of a variable frequency drive (VFD).

FIG. 6 is an illustration of one embodiment of a motor controller.

FIG. 7 is an illustration of one embodiment of a generator.

FIG. 8 is an illustration of one embodiment of a bypass.

FIG. 9 is one embodiment of a mobile compressor startup drive.

FIG. 10 is another embodiment of a mobile compressor startup drive.

FIG. 11 is another embodiment of a mobile compressor startup drive.

FIG. 12 is another embodiment of a mobile compressor startup drive.

FIG. 13 is another embodiment of a mobile compressor startup drive.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting. As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “alternating current” or “AC” refers to electrical current that reverses direction at regular intervals.

As used herein, the term “current” or “electrical current” refers to the movement of electrons through electrical equipment or electronic equipment.

As used herein, the term “central processing unit” or “CPU” refers to a complex set of electronic circuitries that interprets, processes, and executes instructions.

As used herein, the term “communication bus,” “control bus,” “bus lines,” or “bus” refers to a system that transfers data between components inside an electronic device and may communicate with external electronic device(s).

As used herein, the term “direct current” or “DC” refers to an electric current that flows in one direction.

As used herein, the term “duty cycle” refers to the ratio of time a DC is ON compared to the time the DC is OFF.

As used herein, the term “electric generator” or “generator” refers to devices that convert motion-based power or fuel-based power into electric power.

As used herein, the term “electric power” refers to the rate at which electrical energy is transferred by an electric circuit. Typically measured in watts and is the product of voltage and current over.

As used herein, the term “generator” refers to a source of electrical power. A generator may be any source that can supply steady state current but cannot accommodate large and fast changes in current demand.

As used herein, the term “horsepower” or “HP” refers to the measurement of power based on work output. The output power of an electric motor may be measured in HP.

As used herein, the term “inrush current” or “locked rotor current” refers to the excessive electrical current flow that occurs in an electric motor and its conductors when the electric motor is turned on or first started up.

As used herein, the term “mechanical output power” refers to the rate at which mechanical energy is delivered to a system. It's often measured in horsepower but can also be measured in watts.

As used herein, the term “pulse width modulation” or “PWM” refers to a method of controlling the average power or amplitude delivered by an electrical signal. The average value of voltage (and current) supplied to a load is controlled by switching the supply between 0 and 100% at a rate faster than it takes the load to change significantly. The longer the switch is on, the higher the total power supplied to the load.

As used herein, the term “rectify” refers to the process of converting alternating current (AC) to direct current (DC).

As used herein, the term “relay” refers to an electromagnetic device for remote or automatic control of an electric circuit.

As used herein, the term “wireless” or “radio” refers to devices (such as transmitters, receivers, and transceivers), systems, and methods, for sending wireless signals to transmit and receive data.

As used herein, the term “steady-state” or “steady-state current” refers to when the magnitude of the current stays substantially the same and substantially without fluctuations over a period of time within an electric system. An electric system is in steady-state when the current at each point in the circuit is substantially constant.

As used herein, the term “TRIAC” refers to bidirectional, three-electrode AC switches that allow electrons to flow in either direction.

As used herein, the term “watts” or “W” refers to the measures of power over time. The input power of an electric motor is measured in W.

As used herein, the term “wireless radio” refers to a device that uses wireless signals to transmit and receive data.

As used herein, the term “variable frequency drive” or “VFD” refers to the type of motor controller that drives an electric motor by varying the frequency and voltage of its power supply.

As used herein the term “battery,” “power bank,” or “electric power bank” refer to a source of electric power or energy. A power bank may be a battery, multiple batteries, or one or more cells. A battery typically comprises one or more electrochemical cells with external connections for powering electrical devices. A power bank or battery may be used when a generator cannot be connected to a power grid.

As used herein the term “capacitor” refers to a passive electronic component that stores electrical energy in an electric field.

As used herein the term “charger” or “power bank charger” or “DC charger” refers to a device that recharges an energy source, such as a battery or power bank.

As used herein, the term “data bit(s)” or “bit(s)” refers to a binary digit, the smallest unit of data that a computer can process and store.

As used herein the term “inverter” refers to an electronic device that converts DC to AC, in order to provide AC to various devices that require AC from a DC source.

As used herein the term “bypass” or “bypass switch” refers to an electronic switch that redirects electrical power.

A combination of current sources and devices may assist a standalone current source in meeting the inrush current requirements of an electrically driven compressor, allowing for smaller current sources and devices, which may reduce costs.

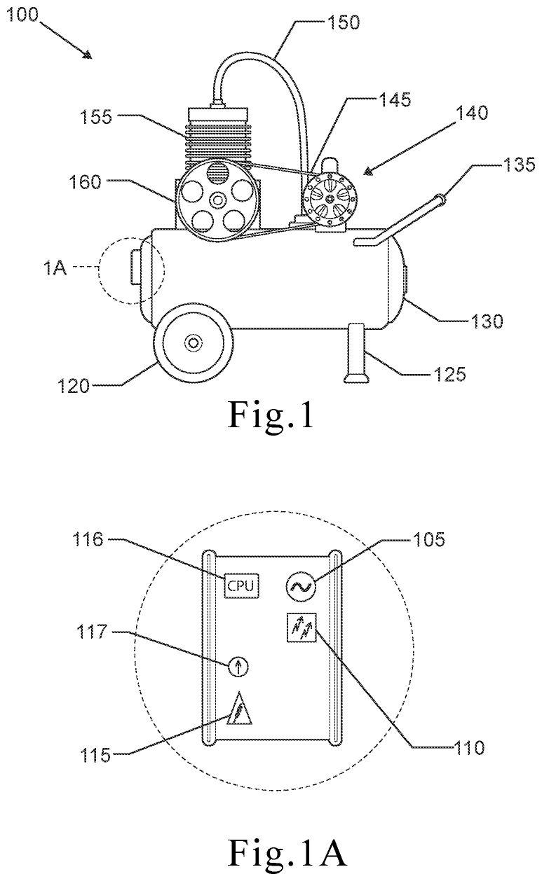

FIG. 1 is an illustration of one embodiment of an electrically driven compressor. FIG. 1A is an illustration of one embodiment of a compressor control unit. Electrically driven compressor 100 may comprise control unit 1A, which is shown in more detail in FIG. 1A. As shown in FIG. 1A, the control unit may comprise motor current lines 105, motor control bus 110, VFD control lines 115, central processing unit 116, and current sensor 117. The electrically driven compressor 100 may further comprise wheels 120, supports 125, tank 130, transport handle 135, electric motor 140, drive belt 145, pressure line 150, compressor pump 155, and compressor drive pulley 160.

Motor current lines 105 may comprise 100 volt AC, 110 volts AC, 115 volts AC, 120 volts AC, 127 volts AC, 220 volts AC, 230 volts AC, 240 volts AC, and 440 volts AC configurations. Current sensor 117 may determine current draw of electrical motor 140. Motor control bus 110 may manage and allow communications and control between central processing unit 116 and electrically driven compressor 100.

Central processing unit 116 may process data, store data, output results, transmit commands to devices, coordinate control activity, connect input or output, and/or disconnect input or output. Further, central processing unit 116 may measure electric current draw, DC and AC voltage, revolutions per minute (“RPM”), pressure, AC starting current, and AC steady-state current.

Motor control bus 110 may manage and allow communications and control between a central processing unit 116, electrically driven compressor 100, and external processing units or control buses. Motor control bus 110 may utilize serial communication protocols to move data bits sequentially, or one at a time, between components or separate devices. Communication Protocols such as but not limited to, NMEA 2000, NMEA 0183, control area network (“CAN bus”), transmission control protocol/internet protocol (“TCP/IP”), user datagram protocol (“UDP”), UART, I2C, SPI, LIN, and FlexRay® may be used. Motor control bus 110 may be bidirectional. Motor control bus 110 may be wireless connections, such as radios, transmitters, receivers, and/or transceivers, and/or physical connections, such as cables or printed circuits. Motor control bus 110 may transfer control signals that coordinate and regulate the electrically driven compressor 100. Motor control bus 110 may transmit commands to memory or I/O devices, coordinating control activity, and providing electric current draw, voltage, revolutions per minute (“RPM”), pressure, and operational status to the central processing unit 116.

One embodiment of electrically driven compressor 100 may utilize a variable frequency drive that utilizes VFD control lines 115. VFD control lines 115 may be analog or digital control lines. Digital controls may offer stopping, starting, and variable speed control.

One embodiment of electrically driven compressor 100 central processing unit 116 and motor control bus 110 may be one unit.

Electric motor 140 may be configured to operate on AC. Electric motor 140 may be configured to operate with variable frequency AC. Electric motor 140 may be rated in terms of input current and mechanical output power and may be measured in horsepower or watts. Electric motor 140 mechanical output power may preferably be rated to operate compressor pump 155. Electric motor 140 input current rating may be rated to operate at a rating lower than the maximum available from the current source to which it may be connected. The electric motor inrush current may be significantly greater than the steady-state current required to operate electric motor 140 on a continuous, normal basis. As electric motor 140 reaches nearly steady RPM, the current required to operate electric motor 140 reaches steady-state current draw.

As shown in FIG. 1, electrically driven compressor 100 may be a portable or mobile unit that may be moved into position or placed onto a truck, trailer, or other transportation device (not shown). As shown in FIG. 1 electrically driven compressor may include wheels 120, supports 125, and transport handle 135. Tank 130 may have volume and pressure capacity not limited by this disclosure. Drive belt 145 may be gears, rubber belts, chains, or other means of transferring torque from electric motor 140 to compressor pump 155. In another embodiment electric motor 140 may directly drive compressor pump 155 not requiring gears, rubber belts, chains, or other means of transferring torque. Pressure lines 150 may be configured to pass pressurized gas from compressor pump 155 to tank 130. Compressor pump 155 may be configured to produce and provide pressurized gas at rated pressures and volumes not limited by this disclosure. Although shown as a mobile compressor the electrically driven compressor 100 of the present disclosure is not to be limited to any specific compressor.

Compressor drive pulley 160 may be configured to transfer torque from drive belt 145 to compressor pump 155.

In an alternate embodiment compressor pump 155 may be a directly driven electrical motor.

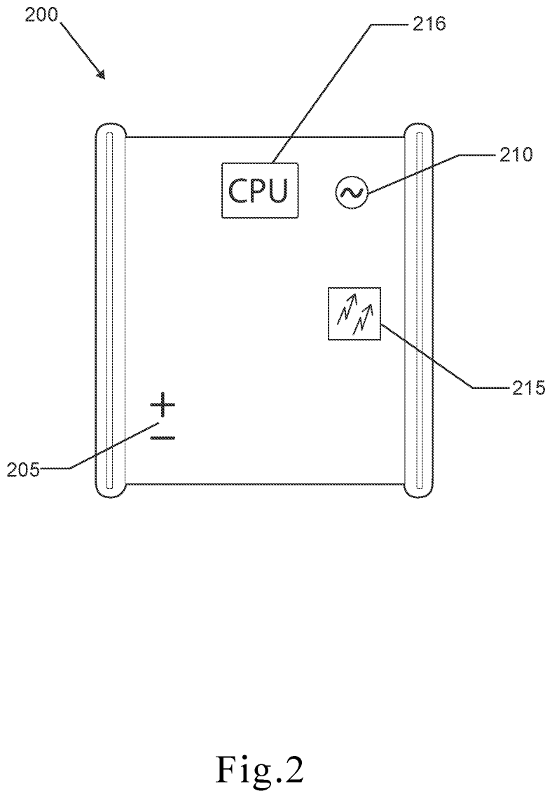

FIG. 2 is an illustration of one embodiment of an inverter. Inverter 200 may convert DC from a power bank to AC to be used by the compressor 100. Inverter 200 may comprise DC input 205, inverter output current 210, inverter control bus 215, and central processing unit 216. Inverter 200 may be rated by the voltage and current output and may be typically rated in watts. Inverter 200 may have three current and voltage ratings: continuous, limited time, and surge. Continuous means the amount of current and voltage inverter 200 can supply indefinitely. Limited means the maximum current and voltage inverter 200 can supply for a limited period of time. Surge means the maximum amount of current and voltage inverter 200 can supply in a short period of time.

DC input 205 may be configured to accept any DC source capable of providing continuous DC at inverter 200 continuous, limited, and surge current and voltage ratings.

Inverter output current 210 may be configured to provide continuous AC at an appropriate frequency, voltage, and current required by an electric motor.

Central processing unit 216 may process data, store data, output results, transmit commands to devices, coordinate control activity, connect input or output, and/or disconnect input or output. Further, central processing unit 216 may measure current draw, DC and AC voltage, AC frequency, AC starting current, and/or AC steady-state current.

Inverter control bus 215 may manage and allow communications and control between a central processing unit 216, inverter 200, and external processing units or control buses. Inverter control bus 215 may utilize serial communication protocols to move data bits sequentially, or one at a time, between components or separate devices. Communication Protocols such as but not limited to, NMEA 2000, NMEA 0183, CAN bus, TCP/IP, UDP, UART, I2C, SPI, LIN, and FlexRay® may be used. Inverter control bus 215 may be bidirectional. Inverter control bus 215 may be wireless connections, such as radios, transmitters, receivers, and/or transceivers, and/or physical connections, such as cables or printed circuits. Inverter control bus 215 may transfer control signals that coordinate and regulate the inverter 200. Inverter control bus 215 may transmit commands to memory or I/O devices, coordinating control activity, providing electric current draw, DC source voltage, AC voltage output, AC output, and operational status to the central processing unit 216.

One embodiment of inverter 200 central processing unit 216 and inverter control bus 215 may be one unit.

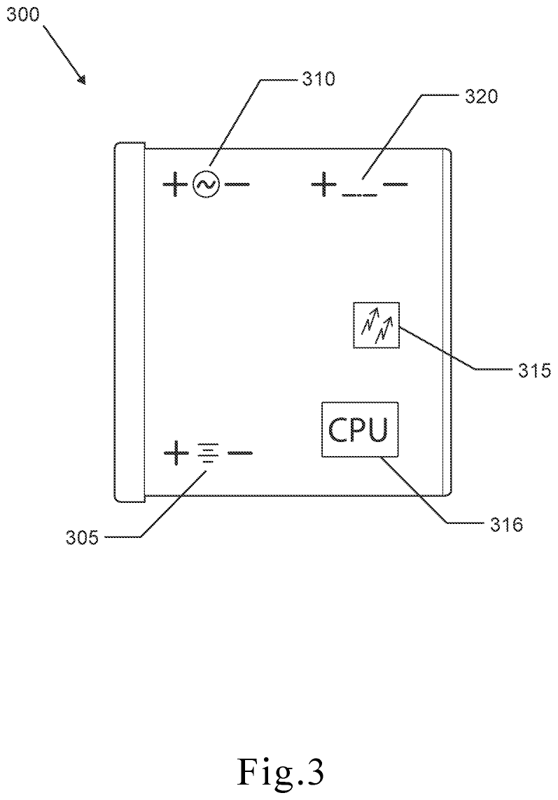

In some embodiments, inverter 200 may be integrated into one unit with DC charger 300, shown in FIG. 3.

FIG. 3 is an illustration of one embodiment of a power bank charger. Power bank (or DC) charger 300 may comprise DC storage output 305, DC charge input 310, charger control bus 315, central processing unit 316, and DC supply output 320. DC storage output 305 may be configured to output voltage and current capable of being stored in a power bank. DC storage output 305 may preferably be configured to continuously supply controlled voltage and current to the power bank (or other storage source or storage unit) until charging is complete. Each storage source may have particular charging specifications, and DC charger 300 may preferably be configured to meet the specifications of the storage source to which it may be connected. Once the storage source is charged, DC storage output 305 may cease supplying voltage and current to the storage source.

DC charge input 310 may be commercial AC, generator AC, or alternator AC source. DC charger 300 may rectify an AC into DC. DC charge input 310 may be configured to filter, convert, and regulate the DC and provide charging current.

DC supply output 320 may be configured to supply constant DC voltage and current. DC supply output 320 may be configured to source the maximum current and voltage an electric power storage device (not shown) may provide.

Central processing unit 316 may process data, store data, output results, transmit commands to devices, coordinate control activity, connect input or output, and/or disconnect input or output. Further, central processing unit 316 may measure current draw, and DC voltage.

Charger control bus 315 may manage and allow communications and control between the central processing unit 316, charger 300, and external processing units or control buses. Charger control bus 315 may utilize serial communication protocols to move data bits sequentially, or one at a time, between components or separate devices. Communication Protocols such as but not limited to, NMEA 2000, NMEA 0183, CAN bus, TCP/IP, UDP, UART, I2C, SPI, LIN, and FlexRay® may be used. Charger control bus 315 may be bidirectional. Charger control bus 315 may be wireless connections, such as radios, transmitters, receivers, and/or transceivers, and/or physical connections, such as cables or printed circuits. Charger control bus 315 may transfer control signals that coordinate and regulate charger 300. Charger control bus 315 may transmit commands to memory or I/O devices, coordinating control activity, providing electric charge current, DC storage voltage, AC input voltage, DC output, and operational status to the central processing unit 316.

One embodiment of charger 300 central processing unit 316 and charger control bus 315 may be one unit.

Charger 300 may be integrated into a single unit with inverter 200.

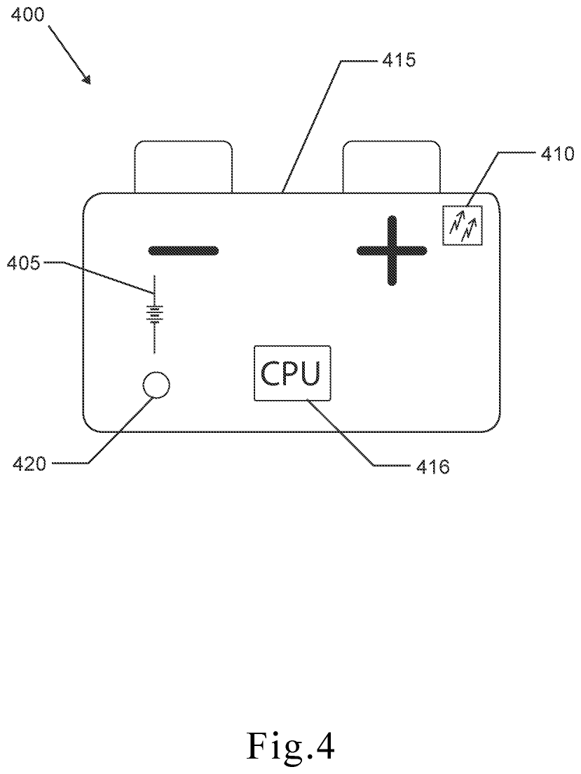

FIG. 4 is an illustration of one embodiment of a power bank. Power bank 400, which may be one, two, or more batteries may comprise power cell(s) 405, power bank control bus 410, central processing unit 416, DC storage output, and power bank input 420.

Power cell(s) 405 may be constructed from a plurality of battery cells, a plurality of capacitors, or any other storage or conversion of energy to electricity.

DC storage output 415 may be configured to source DC to an inverter, microcontroller, or other device requiring DC. The DC from DC storage output 415 may be configured to supply significantly large currents for a short duration. DC storage output 415 may supply continuous current for electrically driven compressor 100, inverter 200, charger 300, and motor controller 600.

Power bank input 420 may receive energy to be stored from a generator via charger 300, a hydroelectric plant, an elevated mass, or any other source of energy.

Central processing unit 416 may process data, store data, output results, transmit commands to devices, coordinate control activity, connect input or output, and/or disconnect input or output. Further, central processing unit 416 may measure current draw, and DC voltage.

Power bank control bus 410 may manage and allow communications and control between a central processing unit 416 power bank 400, and external processing units or control buses. Power bank control bus 410 may utilize serial communication protocols to move data bits sequentially, one at a time, between components or separate devices. Communication Protocols such as but not limited to, NMEA 2000, NMEA 0183, CAN bus, TCP/IP, UDP, UART, I2C, SPI, LIN, and FlexRay® may be used. Power bank control bus 410 may be bidirectional. Power Bank control bus 410 may be wireless connections, such as radios, transmitters, receivers, and/or transceivers, and/or physical connections, such as cables or printed circuits. Power bank control bus 410 may transfer control signals that coordinate and regulate power bank 400. Power bank control bus 410 may but should not be limited to transmitting commands to memory or I/O devices, coordinating control activity, providing electric charge current, DC storage voltage, DC output, and operational status to a central processing unit 416.

One embodiment of power bank 400 central processing unit 416 and power bank control bus 410 may be one unit.

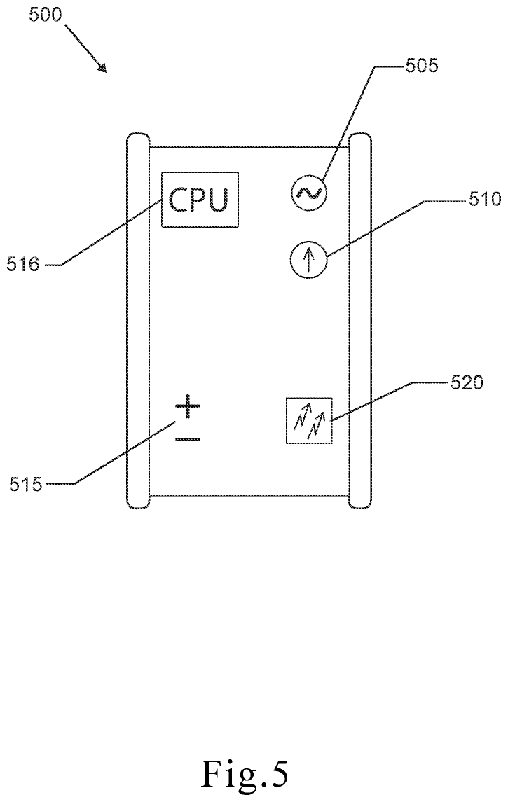

FIG. 5 is an illustration of one embodiment of a variable frequency drive (VFD). VFD 500 may comprise output current 505, current sensor 510, input current 515, central processing unit 516, and VFD control bus 520. VFD 500 may be a type of motor controller that drives an electric motor by varying the frequency and voltage of input current. VFD 500 may be able to control ramp-up and ramp-down electric motor 140 during start or stop, respectively. VFD 500, as electrically driven compressor 100 inrush current decreases as measured by current sensor 510, may change the speed of the electric motor 140 that turns the compressor pump 155, reducing the inrush current. VFD 500 may have external current and speed sensors to monitor electrically driven compressor 100.

Output current 505 may be in the form of single-phase AC, dual phase AC, or three phase AC to supply current to an electrical motor. Current sensor 510 may determine current draw of an electrical motor. Input current 515 may typically be AC.

Central processing unit 516 may process data, store data, output results, transmit commands to devices, coordinate control activity, connect input or output, and/or disconnect input or output. Further, central processing unit 516 may measure electric current draw, DC and AC voltage, AC frequency, AC starting current, and AC steady-state current.

VFD control bus 520 may manage and allow communications and control between the central processing unit 516, VFD 500, and external processing units or control buses. VFD control bus 520 may utilize serial communication protocols to move data bits sequentially, or one at a time, between components or separate devices. Communication Protocols such as but not limited to, NMEA 2000, NMEA 0183, CAN bus, TCP/IP, UDP, UART, I2C, SPI, LIN, and FlexRay® may be used. VFD control bus 520 may be bidirectional. VFD control bus 520 may be wireless connections, such as radios, transmitters, receivers, and/or transceivers, and/or physical connections, such as cables or printed circuits. VFD control bus 520 may transfer control signals that coordinate and regulate VFD 500. VFD control bus 520 may transmit commands to memory or I/O devices, coordinating control activity, controlling electric motor drive current, and operational status to a central processing unit 516.

One embodiment of VFD 500 central processing unit 516 and VFD control bus 520 may be one unit.

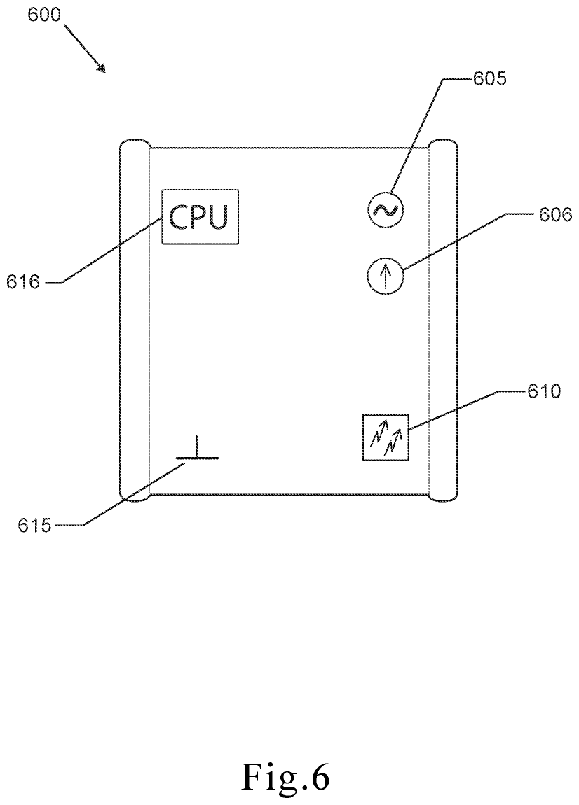

FIG. 6 is an illustration of one embodiment of a motor controller. Motor controller 600 may comprise output current 605, current sensor 606, and motor controller input current 615, central processing unit 616. Motor controller 600 may control DC motors where greater current may be required to start the motor and current lower than the starting current required to operate. Changing the motor from a greater current to a lower current may be a function of motor controller 600. Motor controller 600 may be an electronic device that manages the performance of a DC motor. Motor controller 600 may start and stop the motor and control its speed, torque, and rotational direction.

Motor controller 600 input current may be from power bank 400, which may be directly connected to motor controller 600. Output current 605 may output the controlled supply current from motor controller 600.

Output current 605 may be in the form of DC or pulse width modulation (“PWM”) to supply current to an electrical motor.

Current sensor 606 may determine the current draw of an electrical motor.

Central processing unit 616 may process data, store data, output results, transmit commands to devices, coordinate control activity, connect input or output, and/or disconnect input or output. Further, central processing unit 616 may measure electric current draw, and DC voltage.

Motor controller control bus 610 may manage and allow communications and control between the central processing unit 616, motor controller 600, and external processing units or control buses. Motor controller control bus 610 may utilize serial communication protocols to move data bits sequentially, or one at a time, between components or separate devices. Communication Protocols such as but not limited to, NMEA 2000, NMEA 0183, CAN bus, TCP/IP, UDP, UART, I2C, SPI, LIN, and FlexRay® may be used. Motor controller control bus 610 may be bidirectional. Motor controller control bus 610 may be wireless connections, such as radios, transmitters, receivers, and/or transceivers, and/or physical connections, such as cables or printed circuits. Motor controller control bus 610 may transfer control signals that coordinate and regulate motor controller 600. Motor controller control bus 610 may transmit commands to memory or I/O devices, coordinating control activity, DC starting current, DC steady-state current, and operational status to a central processing unit 616.

One embodiment of motor control 600 central processing unit 616 and motor control bus 610 may be one unit.

Motor controller input current 615 may typically be DC and preferably rated to exceed load requirements.

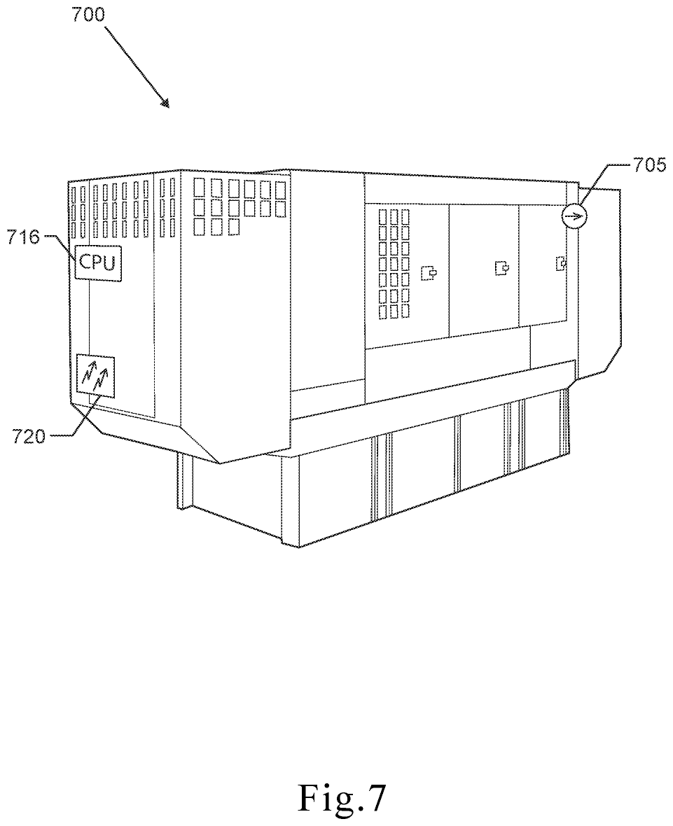

FIG. 7 is an illustration of one embodiment of a generator. Generator 700 may comprise one or more outputs, such as, but not limited to, power output 705, central processing unit 716, and generator control bus 720.

Power output 705 may provide 100-440 volts AC and AC current to directly drive electrically driven compressor 100, which may or may not have VFD 500. Generator 700 may also provide 100-440 volts AC and AC current, via power output 705, to charger 300 or to an inverter 200/charger 300 combination device, which then supplies the AC generated by generator 700 to compressor 100, which may or may not have VFD 500. Generator 700 may also separately supply 100-440 volts AC and AC current from power output 705, to the power bank 400 through charger 300. Generator 700 typically outputs 100-440 volts AC and AC current to power output 705. Generator 700 may supply 100-440 volts single, dual, or three-phase AC.

Central processing unit 716 may process data, store data, output results, transmit commands to devices, coordinate control activity, connect input or output, and/or disconnect input or output. Further, central processing unit 716 may measure electric current draw, AC voltage, generator revolutions per minute (“RPM”), and AC current.

Generator control bus 720 may manage and allow communications and control between the central processing unit 716 generator 700, and external processing units or control buses. Generator control bus 720 may utilize serial communication protocols to move data bits sequentially, or one at a time, between components or between separate devices. Communication Protocols such as but not limited to, NMEA 2000, NMEA 0183, CAN bus, TCP/IP, UDP, UART, I2C, SPI, LIN, and FlexRay® may be used. Generator control bus 720 may be bidirectional. Generator control bus 720 may be wireless connections, such as radios, transmitters, receivers, and/or transceivers, and/or physical connections, such as cables or printed circuits. Generator control bus 720 may transfer control signals that coordinate and regulate generator 700. Generator control bus 720 may transmit commands to memory or I/O devices, coordinating control activity, AC starting current, AC steady-state current, and operational status to a central processing unit 716.

One embodiment of generator 700 central processing unit 716 and generator control bus 720 may be one unit.

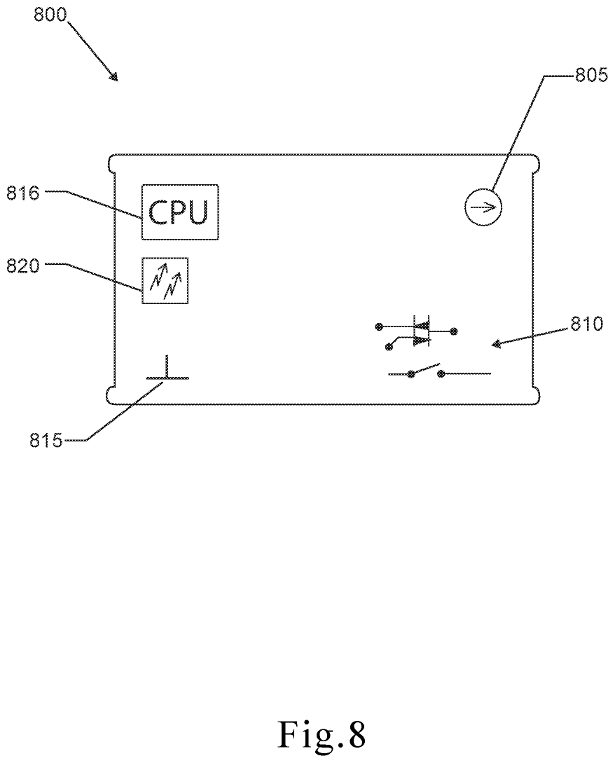

FIG. 8 is an illustration of one embodiment of a bypass. Bypass 800 may comprise output 805, transfer circuitry 810, input 815, and bypass control bus 820. Bypass 800 may enable generator 700 to be directly connected to electrically driven compressor 100, which may or may not have VFD 500, during steady-state current needs and may be disconnected from compressor 100 during start-up or inrush current needs of electrically driven compressor 100. Bypass 800 may be disengaged during inrush current needs therefore power bank 400 may supply the inrush current needs. Transfer circuitry 810 may electrically connect and disconnect input 815 and output 805. Transfer circuitry 810 may be relay-type contact(s) or semiconductor TRIAC(s).

Central processing unit 816 may process data, store data, output results, transmit commands to devices, coordinate control activity, connect input or output, and/or disconnect input or output.

Bypass control bus 820 may manage and allow communications and control between the central processing unit 816 and bypass 800. Bypass control bus 820 may utilize serial communication protocols to move data bits sequentially, or one at a time, between components or between separate devices. Communication Protocols such as but not limited to, NMEA 2000, NMEA 0183, CAN bus, TCP/IP, UDP, UART, I2C, SPI, LIN, and FlexRay® may be used. Bypass control bus 820 may be bidirectional. Bypass control bus 820 may be wireless connections, such as radios, transmitters, receivers, and/or transceivers, and/or physical connections, such as cables or printed circuits. Bypass control bus 820 may transfer control signals that coordinate and regulate bypass 800. Bypass control bus 820 may transmit commands to memory or I/O devices, coordinating control activity, connecting input to output, disconnecting input to output, and operational status to a central processing unit 816.

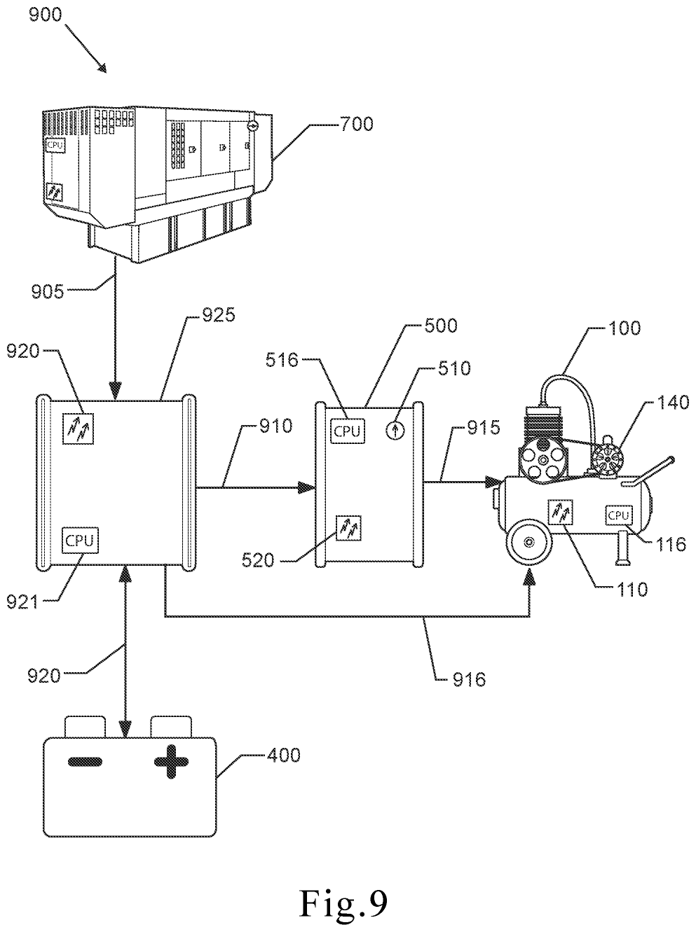

FIG. 9 is one embodiment of a mobile compressor start-up drive. Mobile compressor start-up drive 900 may comprise generator 700, GEN to INV/CHG bus and current output 905, inverter/charger unit (INV/CHG) 925, INV/CHG to VFD bus and current output 910, VFD 500, VFD to compressor bus and current output 915, electrically driven compressor 100, power bank 400, and power bank to INV/CHG bus and current output 920. GEN to INV/CHG bus and current output 905, INV/CHG to VFD bus and current output 910, VFD to compressor bus and current output 915, and power bank to INV/CHG bus and current output 920, may each be single communication and current cable or multiple current and communication cables or lines. In an alternate embodiment, there may be no VFD 500, and current may be output from the generator 700 and/or power bank 400 through INV/CHG to compressor bus and current output 916.

Mobile compressor start-up drive 900 may control and provide the inrush current needed to start-up electrically driven compressor 100. In one embodiment, VFD 500, current sensor 510 may detect the inrush current need of electrically driven compressor 100. VFD 500 through VFD control bus 520 may control the speed of electric motor 140 of electrically driven compressor 100, through motor control bus 110 or varying the AC frequency. VFD 500 may provide current and communicate to electrically driven compressor 100 through VFD to compressor bus and current output 915.

In one embodiment, mobile compressor start-up drive 900 may control and provide the inrush current needed to start-up electrically driven compressor 100. In one embodiment, inverter/charger INV/CHG 925 through INV/CHG control bus 920 may control the speed of electric motor 140 of electrically driven compressor 100, through motor control bus 110. INV/CHG 925 may provide current and communicate to electrically driven compressor 100 through INV/CHG to compressor bus and current output 916.

Central processing unit 921 may process data, store data, output results, transmit commands to devices, coordinate control activity, connect input or output, and/or disconnect input or output. Further, central processing unit 921 may measure current draw, DC and AC voltage, AC starting current, and/or AC steady-state current.

VFD 500 central processing unit 516 may coordinate or control electrically driven compressor 100 through central processing unit 616.

INV/CHG control bus 920 may manage and allow communications and control between the central processing unit 921, INV/CHG 925, and external processing units or control buses. INV/CHG control bus 920 may utilize serial communication protocols to move data bits sequentially, or one at a time, between components or separate devices. Communication Protocols such as but not limited to, NMEA 2000, NMEA 0183, CAN bus, TCP/IP, UDP, UART, I2C, SPI, LIN, and FlexRay® may be used. Motor controller control bus 610 may be bidirectional. INV/CHG control bus 920 may be wireless connections, such as radios, transmitters, receivers, and/or transceivers, and/or physical connections, such as cables or printed circuits. INV/CHG control bus 920 may transfer control signals that coordinate and regulate INV/CHG 925. INV/CHG control bus 920 may transmit commands to memory or I/O devices, coordinating control activity, DC starting current, DC steady-state current, and operational status to a central processing unit 921.

Generator 700 may be rated to provide, at a minimum, the steady-state current required to operate electrically driven compressor 100. Generator 700 may supply current and communicate between INV/CHG 925 through GEN to INV/CHG bus and current output 905. Generator 700, through generator control bus 720, may provide or determine INV/CHG 925 operational status and capability.

Power bank 400 may provide the additional current required to meet the inrush current need of electrically driven compressor 100. Power bank 400 may connect current and communications between INV/CHG 925 through power bank to INV/CHG bus and current output 920. Power bank 400 through power bank control bus 410 may provide INV/CHG 925 operational status and capability.

INV/CHG 925 may provide current and/or status data to VFD 500 or directly to compressor 100. INV/CHG 925 may accept current from generator 700 and power bank 400. INV/CHG 925 may receive current and communications from generator 700 and power bank 400 through GEN to INV/CHG bus and current output 905 and power bank to INV/CHG bus and current output 920. INV/CHG 925 may provide a charge current to charge power bank 400. Typically, this recharging may happen when generator 700 may be operating at steady-state to provide the current needs of electrically driven compressor 100. INV/CHG 925 may supply additional or surge current needs of electrically driven compressor 100 that are not provided by generator 700. INV/CHG 925 may determine the current handling capabilities of generator 700 and power bank 400, through communications with generator control bus 720 and power bank control bus 410. INV/CHG 925 may balance between the current supplied from generator 700 and power bank 400.

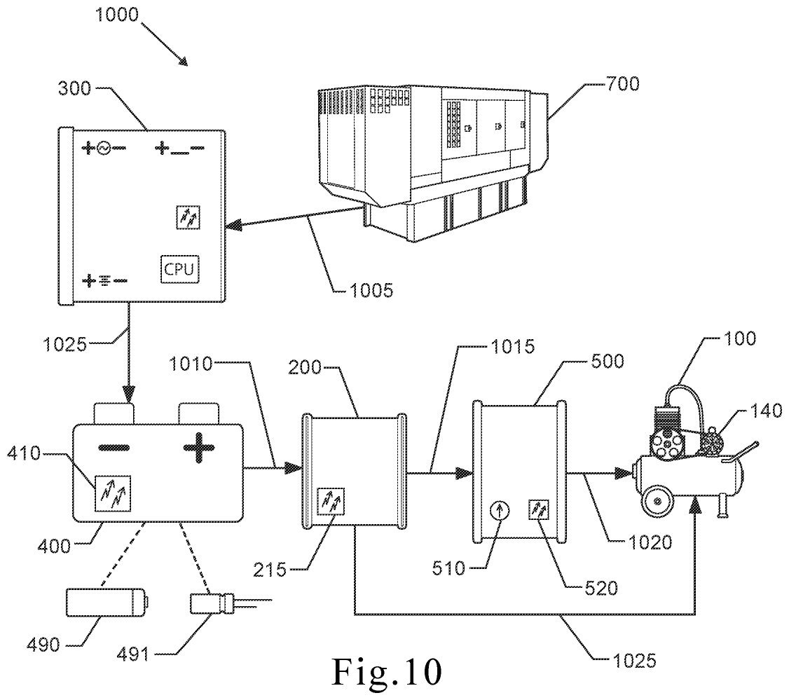

FIG. 10 is another embodiment of a mobile compressor start-up drive. Mobile compressor start-up drive 1000 may comprise generator 700, GEN to CHG bus and current output 1005, DC charge 300, CHG to power bank bus and current output 1025, power bank 400, power bank to INV bus and current output 1010, inverter 200, INV to VFD bus and current output 1015, VFD 500, VFD to compressor bus and current output 1020, and electrically driven compressor 100. GEN to CHG bus and current output 1005, CHG to power bank and bus power 1025, power bank to INV bus and current output 1010, INV to VFD bus and current output 1015, VFD to compressor bus and current output 1020, may each be single communication and current cable or multiple current and communication cables or lines. In one embodiment power bank 400 may be one or more batteries 490. In another embodiment, power bank 400 may be one or more capacitors 491. In another embodiment, power bank 400 may comprise one or more batteries 490 and capacitors 491.

As shown in FIG. 10, mobile compressor start-up drive 1000 may control the inrush current supplied to electrically driven compressor 100 via VFD 500 and power bank 400. In an alternate embodiment a VFD may not be a part of the start-up drive and the inrush current needed to start compressor 100 may be supplied by power bank 400 without the assistance of a VFD. VFD 500 current sensor 510 may detect the inrush current need of electrically driven compressor 100. VFD 500, through VFD control bus 520, may control the speed of electric motor 140 of the electrically driven compressor 100 through electrically driven compressor 100 motor control bus 110. VFD 500, as an intermediary device, or as a part integrated into compressor 100, may provide current and communicate to electrically driven compressor 100 through VFD to Compressor bus and current output 1020.

Generator 700 may be rated to provide, at a minimum, the steady-state current required to operate electrically driven compressor 100. Preferably, generator 700 is not rated to be able to provide the startup inrush current requirements of compressor 100. Generator 700 may supply current and communicate between charger 300 through GEN to CHG bus and current output 1005. Generator 700 through generator control bus 720 may provide DC charger 300 operational status and capability.

Charger 300 may preferably be configured to pass through or provide the steady-state current required to both operate electrically driven compressor 100 and charge power bank 400.

Power bank 400 may preferably pass through or provide the steady-state current required to operate electrically driven compressor 100, and, in addition, provide the additional current required to meet the inrush current needs of electrically driven compressor 100 at startup.

Power bank 400 may provide current and communicate to inverter 200 through power bank to INV bus and current output 1010. Power bank 400 may provide current handling capabilities and DC voltage status to inverter 200 through power bank control bus 410.

Inverter 200 may provide current handling capabilities and AC voltage status to VFD 500. Inverter 200 may receive supply current from power bank 400.

Electrically driven compressor 100 may be controlled and operated by VFD 500. VFD 500 may provide all current needs and control electrically driven compressor 100 through VFD to compressor bus and current output 1020. Electrically driven compressor 100 may report speed and current requirements to VFD from motor control bus 110 VFD control bus 520 through VFD to compressor bus and current output 1020.

In one embodiment, mobile compressor start-up drive 1000 may control and provide the inrush current needed to start-up electrically driven compressor 100. In one embodiment, inverter 200 through inverter control bus 215 may control the speed of electric motor 140 of electrically driven compressor 100 through motor control bus 110. Inverter 200 may provide current and communicate to electrically driven compressor 100 through inverter to compressor bus and current output 1025.

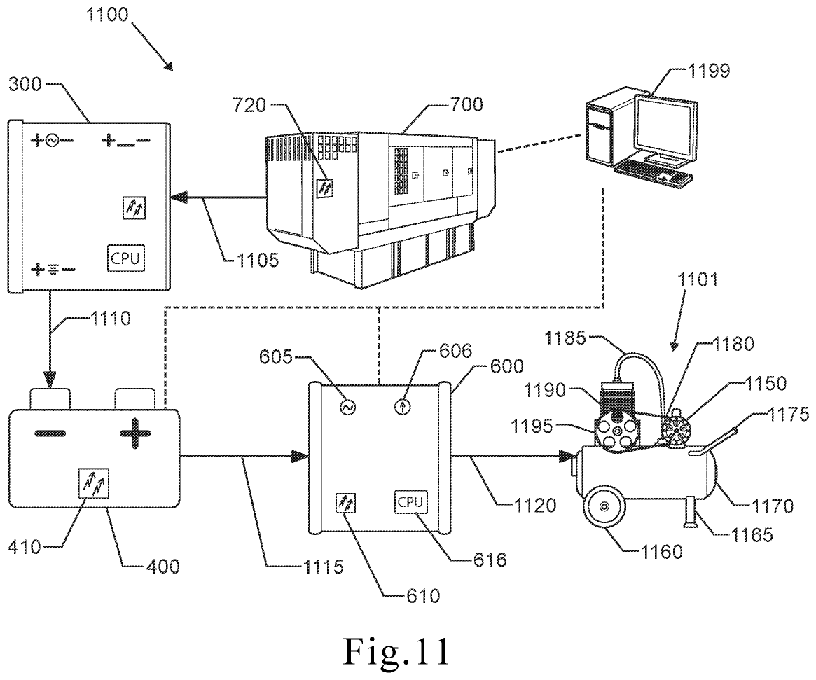

FIG. 11 is another embodiment of a mobile compressor startup drive. Mobile compressor startup drive 1100 may comprise generator 700, GEN to CHG bus and current output 1105, charger 300, CHG to power bank bus and current output 1110, power bank 400, power bank to DC controller bus and current output 1115, motor controller 600, DC controller to compressor bus and current output 1120, electrically driven compressor 1150, and generic computer 1199. GEN to CHG bus and current output 1105, CHG to power bank bus and current output 1110, power bank to DC controller bus and current output 1115, and DC controller to compressor bus and current output 1120, may each be single communication and current cable or multiple current and communication cables or lines. In some embodiments, motor controller 600, rather than being a separate device, may be an integrated part of compressor 100.

DC electrically driven compressor 1101 may comprise wheels 1160, supports 1165, tank 1170, transport handle 1175, electric motor 1150, drive belt 1180, pressure line 1185, compressor pump 1190, and compressor drive pulley 1195.

Motor control 600 Output current lines 605 may comprise 1.5-to-100-volt DC configurations. Motor controller 600 current sensor 606 may determine the current draw of electrical motor 1150. Motor control bus 610 may manage and allow communications and control between central processing unit 616 and external devices.

Generic computer 1199 may be a standalone computer, a specialized micro controller, or a remote application capable of providing data communications to another central processing unit. Generic computer 1199 may be configured to control an external central processing unit. Likewise, any central processing unit may be configured to control another central processing unit or generic computer 1199. Generic computer 1199 may be wireless connections, such as radios, transmitters, receivers, and/or transceivers, and/or physical connections, such as cables or printed circuits.

Generic computer 1199 may control motor controller 600 central processing unit 616 through data connections.

Electric motor 1150 may be configured to operate on 1.5-to-100-volt DC configurations and various PWD duty cycles. Electric motor 1150 may be rated in terms of input current and mechanical output power and may be measured in horsepower or watts. Electric motor 1150 mechanical output power may preferably be rated to operate compressor pump 1190. Electric motor 1150 input current rating may be rated to operate at a rating lower than the maximum available from the current source to which it may be connected. The electric motor inrush current may be significantly greater than the steady-state current required to operate electric motor 1150 on a continuous, normal basis. As electric motor 1150 reaches nearly steady RPM, the current required to operate electric motor 1150 reaches steady-state current draw.

As shown in FIG. 11, DC electrically driven compressor 1101 may preferably be a mobile or movable unit that may be moved and placed via wheels 1160, supports 1165, and transport handle 1175. Tank 1170 may have volume and pressure capacity not limited by this disclosure. Drive belt 1180 may be gears, rubber belts, chains, or other means of transferring torque from electric motor 1150 to compressor pump 1190. Pressure lines 1185 may be configured to pass pressurized gas from compressor pump 1190 to tank 1170. Compressor pump 1190 may be configured to produce and provide pressurized gas at rated pressures and volumes not limited by this disclosure.

Compressor drive pulley 1195 may be configured to transfer torque from drive belt 1180 to compressor pump 1190.

Mobile compressor startup drive 1100 may control the inrush current supplied to DC electrically driven compressor 1101 utilizing motor controller 600. Motor controller 600 may detect an inrush current need of DC electrically driven compressor 1101. Motor controller 600 may be used to start and stop, control speed, torque, and rotational direction of electric motor 1150 of DC electrically driven compressor 1101. DC electrically driven compressor 1101 may report speed and current requirements to motor controller 600 through motor control bus 11115.

Generator 700 may be rated to provide, at minimum, the steady-state current required to operate DC electrically driven compressor 1101. Generator 700 may supply current and communicate between DC charger 300 through GEN to CHG bus and current output 1105. Generator 700, through generator control bus 720, may provide the operational status and current handling capability to DC charger 300.

Charger 300 may provide at a minimum the steady-state current required to operate electrically driven compressor 1101 and charge supply power bank 400.

Power bank 400 may preferably pass through or provide the steady-state current required to operate DC electrically driven compressor 1150, and, in addition, provide the additional current required to meet the inrush current needs of DC electrically driven compressor 1150 at startup.

Power bank 400 may connect current and communications between motor controller 600 through power bank to DC motor controller bus and current output 1115. Power bank 400 through power bank control bus 410 may provide the operational status and capability of motor controller 600.

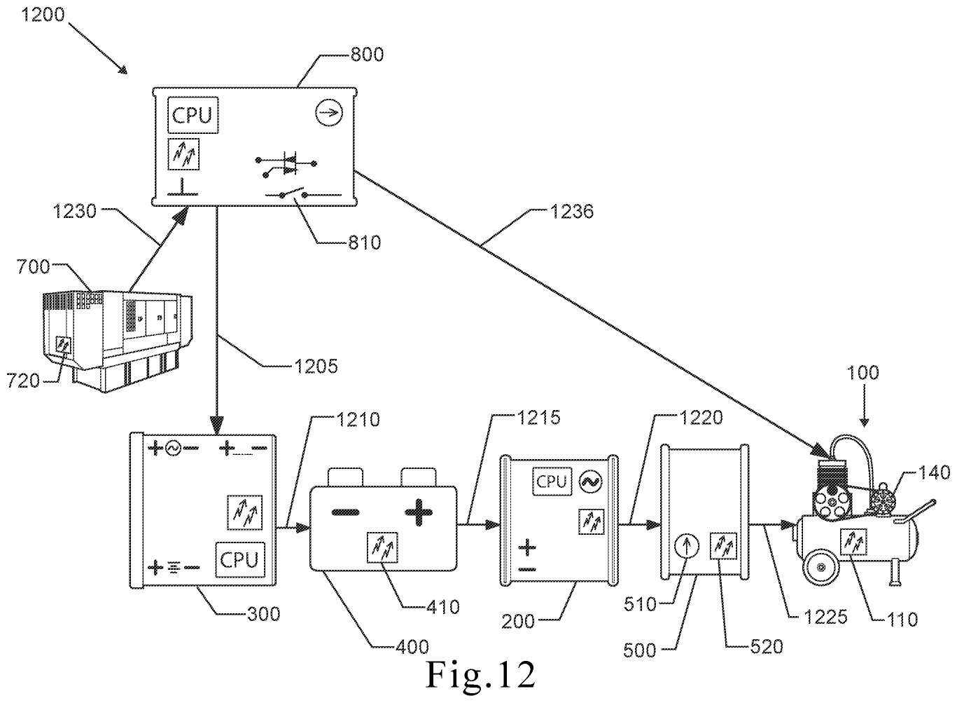

FIG. 12 is another embodiment of a mobile compressor startup drive. Mobile compressor startup drive 1200 may comprise generator 700, BP to CHG bus output 1205, charger 300, CHG to power bank bus and current output 1210, power bank 400, power bank to INV bus and current output 1215, INV 200, INV to VFD bus and current output 1220, VFD 500, VFD to compressor bus and current output 1225, GEN to BP bus and current output 1230, bypass 800, and electrically driven compressor 100. BP to CHG bus output 1205, CHG to power bank bus and current output 1210, power bank to INV bus and current output 1215, INV to VFD bus and current output 1220, VFD to compressor bus and current output 1225, GEN to BP bus and current output 1230, BP to compressor bus and current output 1236, and BP to VFD and current output 1235, may each be single communication and current cable or multiple power and communication cables or lines.

Mobile compressor startup drive 1200 may control how the inrush current is supplied to electrically driven compressor 100. In some embodiments, VFD 500 may provide the inrush current needed, and generator 700 through bypass 800 may provide steady-state current. During startup, VFD 500 may supply inrush current to electrically driven compressor 100 utilizing power bank 400 and inverter 200. VFD 500 current sensor 510 may detect the inrush current need of compressor 100. As the inrush current demand subsides and electrically driven compressor 100 can operate with steady-state current supply, bypass 800 transfer circuitry 810 may switch, allowing generator 700 to directly supply electrically driven compressor 100 with the steady-state current needed for continuing operation.

VFD 500, through VFD control bus 520, may control the speed of electric motor 140 of electrically driven compressor 100 through motor control bus 110. VFD 500 may provide power to and communicate with electrically driven compressor 100 through VFD to Compressor bus and power output 1225. In various embodiments, VFD 500 may be a separate unit or may be an integrated component of compressor 100.

Generator 700 may be rated to provide, at a minimum, the steady-state current required to operate electrically driven compressor 100. Generator 700 may supply charging power and communicate with charger 300 through BP to CHG bus output 1205. Generator 700 through generator control bus 720 may provide DC charger 300 operational status and capability. Generator 700 may supply electrically driven compressor 100 steady-state current through bypass 800.

Charger 300 may accept charge current from generator 700 and then use the current to charge power bank 400. Power bank 400 may provide the additional current required to meet the inrush current needs of electrically driven compressor 100 during startup.

In various embodiments, power bank 400, for at least a limited time, may provide the inrush current needed by compressor 100. Power bank 400 may connect power and communications to inverter 200 via power bank to INV bus and power output 1215. Power bank 400, through power bank control bus 410, may provide inverter 200 operational status and capability.

Inverter 200 may provide power and status to VFD 500. Inverter 200 may receive supply power from power bank 400.

Electrically driven compressor 100 may be controlled and operated by VFD 500 or bypass 800. Electrically driven compressor 100 may connect power and communications between bypass 800 through BP to compressor bus and current output 1236. Alternatively, electrically driven compressor 100 may connect power and communications between VFD 500 through VFD to compressor bus and power output 1225. Electrically driven compressor 100 may report speed and current requirements to VFD 500 through motor control bus 110 and VFD control bus 520. VFD 500 may switch between bypass 800 during steady-state current demand, supplied from generator 700, and inrush or additional current demand, supplied from power bank 400.

Bypass 800 during steady-state current demand connects generator 700 to VFD 500, supplying current to VFD 500 for electrically driven compressor 100.

During a demand for inrush current, bypass 800 may preferably be switched off and disconnect generator 700 from VFD 500 so as not to load down generator 700.

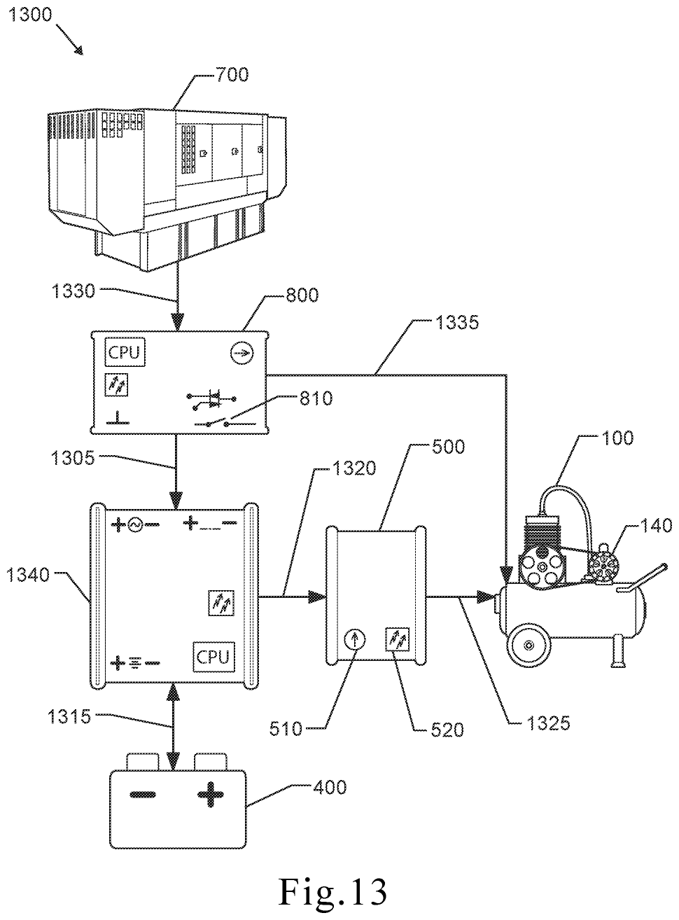

FIG. 13 is another embodiment of a mobile compressor startup drive. Mobile compressor startup drive 1300 may comprise generator 700, BP to INV/CHG bus and power output 1305, INV/CHG 1340, power bank 400, power bank to INV/CHG bus and power output 1315, INV/CHG to VFD bus and power output 1320, VFD 500, VFD to compressor bus and power output 1325, GEN to BP bus and power output 1330, bypass 800, BP to compressor bus and current output 1335, and electrically driven compressor 100. BP to INV/CHG bus and power output 1305, power bank to INV/CHG bus and power output 1315, INV/CHG to VFD bus and power output 1320, VFD to compressor bus and power output 1325, GEN to BP bus and power output 1330, BP to compressor bus and current output 1335, may each be single communication and power cable or multiple power and communication cables or lines.

Mobile compressor startup drive 1300 may control and/or provide the inrush current needed to start electrically driven compressor 100. In some embodiments, VFD 500 may provide the inrush current needed, and generator 700 through bypass 800 may provide steady-state current.

During startup, VFD 500 may supply inrush current to electrically driven compressor 100 utilizing power bank 400 and inverter 200. VFD 500 current sensor 510 may detect the inrush current need of compressor 100. As the inrush current demand subsides and electrically driven compressor 100 can operate with steady-state current supply, bypass 800 transfer circuitry 810 may switch, allowing generator 700 to directly supply electrically driven compressor 100 the steady-state current needed for continuing operation.

VFD 500, through VFD control bus 520, may control the speed of electric motor 140 through motor control bus 110. VFD 500 may provide power and communicate to electrically driven compressor 100 through VFD to Compressor bus and power output 1325.

Generator 700 may be rated to provide, at a minimum, the steady-state current required to operate electrically driven compressor 100. Generator 700, through generator control bus 720, may provide INV/CHG 1340 operational status and capability. Generator 700 may supply electrically driven compressor 100 steady-state current through bypass 800.

Bypass 800 may supply charging power and communicate with INV/CHG 1340 through BP to INV/CHG bus and power output 1305.

INV/CHG 1340 may accept charge current from generator 700 in order to recharge power bank 400.

Power bank 400 may provide the inrush current required to meet the inrush current needs of electrically driven compressor 100. Power bank 400 may connect power and communications between INV/CHG 1340 through power bank to INV/CHG bus and power output 1315. Power bank 400 through power bank control bus 410 may provide INV/CHG 1340 operational status and capability.

INV/CHG 1340 may provide power and status data to VFD 500. INV/CHG 1340 may receive additional supply power from power bank 400.

Electrically driven compressor 100 may be controlled and operated by VFD 500. Electrically driven compressor 100 may connect power and communications between VFD 500 through VFD to compressor bus and power output 1325. Electrically driven compressor 100 may report speed and current requirements to VFD 500 through motor control bus 110 and VFD control bus 520. VFD 500 may switch between bypass 800 during steady-state current demand, supplied from generator 700, and inrush or additional current demand, supplied from power bank 400.

Bypass 800 during steady-state current demand preferably connects generator 700 directly to electrically driven compressor 100. During a demand for inrush current, bypass 800 may be switched off so that power from VFD 500 may supply the inrush current required. This keeps generator 700 from being overloaded.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A mobile compressor startup drive comprising:
a generator;
an inverter;
a charger; and
a power bank;
wherein the generator is rated to, at a minimum, supply a steady-state current required by a compressor;
wherein said power bank provides an additional current through said inverter to said compressor to meet an inrush current demand of said compressor during startup of said compressor; and
wherein said charger is configured to recharge said power bank.

2. The mobile compressor startup drive of claim 1, further comprising a variable frequency drive (VFD);
wherein said VFD is configured to accept said steady-state current and said additional current and electrically power an electric motor of said compressor.

3. The mobile compressor startup drive of claim 1, further comprising a bypass;
wherein said bypass is configured to accept said steady-state current and provide it directly to an electric motor of said compressor.

4. The mobile compressor startup drive of claim 2, further comprising a bypass;
wherein said bypass is configured to accept said steady-state current and provide it directly to said VFD.

5. The mobile compressor startup drive of claim 1, wherein said inverter and said charger are a single unit that is configured to accept said steady-state current and said additional current and electrically power an electric motor of said compressor.

6. The mobile compressor startup drive of claim 1, wherein the steady-state current is provided to said inverter and said charger.

7. The mobile compressor startup drive of claim 1, wherein said charger supplies a charge current to said power bank when said compressor is in a steady-state operation.

8. The mobile compressor startup drive of claim 1, wherein said power bank comprises at least one capacitor.

9. The mobile compressor startup drive of claim 1, wherein said power bank comprises one or more batteries.

10. The mobile compressor startup drive of claim 4, wherein said generator, said inverter, said charger, said VFD, said bypass, and said power bank, are all in electrical communication with and are controlled by a central processing unit.

11. A mobile compressor startup drive comprising:
a generator;
a charger; and
a power bank;
wherein said generator is rated to, at a minimum, supply a steady-state current required by a compressor;
wherein said power bank provides a steady-state current and an additional current to said compressor to meet an inrush current demand of said compressor during startup of said compressor; and
wherein said charger is configured to recharge said power bank.

12. The mobile compressor startup drive of claim 11, further comprising a motor controller;
wherein said motor controller is configured to accept said steady-state current and said additional current and electrically power an electric motor of said compressor.

13. The mobile compressor startup drive of claim 11, wherein said steady-state current and a charge current is provided to said charger from said generator; and
wherein said charger charges said power bank from said charge current.

14. The mobile compressor startup drive of claim 13, wherein said steady-state current and said charge current is provided to said charger from said generator, when said compressor is in a steady-state operation; and
wherein said charger charges said power bank from said charge current, when said compressor is in a steady-state operation.

15. The mobile compressor startup drive of claim 11, wherein said power bank comprises at least one capacitor.

16. The mobile compressor startup drive of claim 11, wherein said power bank comprises one or more batteries.

17. The mobile compressor startup drive of claim 12, wherein said generator, said charger, said power bank, and said motor controller are all in electrical communication with each other and are controlled by a central processing unit.

18. The mobile compressor startup drive of claim 17, wherein said central processing unit is said motor controller central processing unit.

19. The mobile compressor startup drive of claim 17, wherein said generator, said charger, said power bank, said electric motor of said compressor, and said motor controller all operate on direct current.

20. A mobile compressor startup drive comprising:
a generator;
an inverter;
a charger;
a bypass;
a power bank; and
a variable frequency drive (VFD);
wherein said generator is rated to, at a minimum, supply a steady-state current required by a compressor;
wherein said VFD is configured to provide an inrush current to electrically power an electric motor of said compressor;
wherein said bypass is configured to accept said steady-state current and provide said steady-state current to said electric motor of said compressor;
wherein said power bank provides said inrush current through said inverter to said VFD, to provide said inrush current during startup of said compressor;
wherein said bypass is configured to switch between said VFD to provide said inrush current and said generator to provide said steady-state current.
